(19) United States
(12) Patent Application Publication
(10) Pub. No.: US 2007/0002281 A1
(43) Pub. Date: Jan. 4, 2007

(54) Projection screen and image display apparatus

(75) Inventors: Hiroki Yoshikawa, Tokyo (JP); Takanori Hisada, Tokyo (JP); Tetsu Ohishi, Tokyo (JP); Koji Hirata, Tokyo (JP); Daisuke Imafuku, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/450,677

(22) Filed: Jun. 9, 2006

(30) Foreign Application Priority Data
Jul. 4, 2005 (JP) 2005-194494

(51) Int. Cl. G03B 21/14

(52) U.S. Cl. 353/20

(57) ABSTRACT

A fresnel lens sheet has a fresnel center in the vicinity of a lower end, and includes first and second fresnel lens portions respectively formed into concentrically circular shapes. The first fresnel lens portion exists inside a reference circumference, and the second fresnel lens portion exists outside the reference circumference. A conjugate point distance of the second fresnel lens portion is shorter than a conjugate point distance of the first fresnel lens portion. The reference circumference passes through vicinities of cross points between a horizontal centerline, which halves the fresnel lens sheet into upper and lower portions, and left and right ends of the fresnel lens sheet.

### BACKGROUND OF THE INVENTION

1. Field of the Invention

The present invention relates to an image display apparatus that performs magnified projection of an image supplied from an image generation source to thereby display the image on a light-transmissive projection screen. More particularly, the present invention relates to an image display apparatus that projects an image diagonal to the normal line of a projection screen to thereby form the image on the projection screen of a light-transmissive type, and to a projection screen and a fresnel lens sheet that are to be used in the image display apparatus.

2. Description of the Related Art

Conventionally, there are known so-called projection image display apparatuses that operate such that images formed in an image generation source, such as a liquid crystal display (LCD) device, are magnified and projected on a projection screen by using a projection optical unit. In a projection image display apparatus of that type, it is demanded that magnified images are obtained. Concurrently, it is demanded that the depth dimension of the device is reduced. A technique for satisfying such demands is known such as disclosed in Japanese Unexamined Patent Application Publication No. 2001-264627. The publication discloses a projection optical unit having the configuration that performs magnification and projection onto a projection screen from the direction diagonal to the projection screen. In addition, as described further below, in Japanese Unexamined Patent Application Publication No. 1998-282310, there is disclosed a technique of obtaining uniformity in the brightness of an image projected on a light-transmissive projection screen. The publication discloses forming of a plurality of focal distances of a fresnel lens on the light-transmissive projection screen.

### SUMMARY OF THE INVENTION

According to the technique disclosed in the Publication No. 2001-264627, as shown in FIGS. 2 to 7, the center of the optical axis of a projection lens unit is positioned at the vicinity of the lower end (or, an outer side of the lower end) of the projection screen. In such an optical system, a fresnel center of a fresnel lens sheet (center point of a concentrically circular fresnel lens) has to be provided at the vicinity of the lower end of the fresnel lens sheet so as to be aligned with the optical axis center of the projection lens unit.

In the case as disclosed in Publication No. 2001-264627, considerations for brightly displaying the image on the projection screen are not taken into account. This is especially important for the reason that in the case where image light is projected onto the projection screen in the diagonal direction from the lower portion in order to reduce the depth of the device, the incident angle of light rays incident on the vicinity of an upper left, right end portion of the projection screen increases, such that light losses are increased thereby to reduce the brightness of the image in the vicinity of the end portion.

As disclosed in Publication No. 1998-282310, there is a case where, in order to brightly display the image on the projection screen, a conjugate point is provided on the image side (image viewing side), and the light rays are thereby directed to a viewer. The conjugate point refers to a point at which the projected image light is focused by the fresnel lens. According to the technique disclosed in Publication No. 1998-282310, considerations regarding the case where, as described above, the fresnel center is positioned at the vicinity of the lower end of the fresnel lens sheet.

The present invention is made in view of the problems described above. Accordingly, an object of the present invention is to provide a technique well suited for reducing the depth of an image display apparatus and concurrently for brightly displaying images on a projection screen.

In order to achieve the object, in the case that the fresnel center is positioned in either the vicinity/outside of a lower end of the fresnel lens sheet or the vicinity/outside of an upper end of the fresnel lens sheet, the present invention uses at least two types of fresnel lenses. More specifically, the invention uses a first fresnel lens portion formed inside a reference circumference with the fresnel center as a center point and a second fresnel lens portion formed outside the reference circumference. In the invention, a distance on an image-side conjugate point of the second fresnel lens portion is shorter than an image-side conjugate point of the first fresnel lens portion. The reference circumference may be a circumference of the fresnel lens that passes through vicinities of points whereat a horizontal centerline halving the fresnel lens sheet in upper and lower directions crosses with left and right ends of the fresnel lens sheet.

The second fresnel lens portion may include distances of a plurality of image-side conjugate points, in which the distances of the image-side conjugate points become gradually short toward the outside from the reference circumference. In addition, where a diagonal dimension of the projection screen is W, the distance of the image-side conjugate point may be about 10 W or longer or in a range of from about 10 W to 25 W. Further, where an angle (fresnel incident angle) formed between light incident on an arbitrary point of the second fresnel lens portion and a normal line of the projection screen is δ, a distance L of the image-side conjugate point at the point may be set to satisfy the conditions of the following equation:
L≧1.0583 exp(0.0387×δ)

According to the configuration described above, an image light ray at a screen corner portion which image light ray are incident at a relatively wide incident angle can be directed to a viewer, consequently enabling the image to be brightly displayed.

Thus, according to the present invention, an image display apparatus is formed to be thin, and concurrently, images can be brightly displayed.

### BRIEF DESCRIPTION OF THE DRAWINGS

In the accompanying drawings,

FIG. 1 is a partly-cutaway perspective view of an image display apparatus;

FIG. 2 is a YZ cross sectional view showing the configuration of the image display apparatus and optical paths therein;

FIG. 3 is a schematic view of one embodiment of a projection screen of light-transmissive type (light-transmissive projection screen);

FIG. 4 is a schematic view of one embodiment of a fresnel lens sheet as viewed from an image viewing side;

FIG. 5 is a lateral view of the fresnel lens sheet shown in FIG. 4;

FIG. 6 is a graph showing vertical viewing angles of a general light-transmissive projection screen;

FIG. 7 is a graph showing the relationships between conjugate point distances and luminance ratios at an upper left (right) end of the projection screen;

FIG. 8 is a characteristics graph showing increases in reflection losses of a fresnel lens having a conjugate point; and

FIG. 9 is a view of a fresnel lens sheet according to another embodiment of the present invention.

### DETAILED DESCRIPTION OF THE PREFERRED EMBODIMENTS

Embodiments of the present invention will be described herebelow with reference to the accompanying drawings.

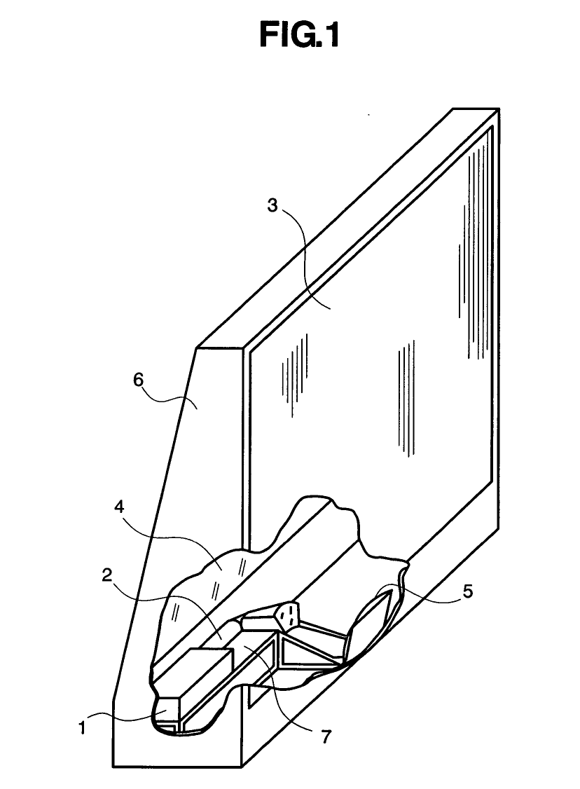

FIG. 1 is a partly-cutaway perspective view of an image display apparatus of an embodiment according to the present invention.

An image generation source 1 displays small images. The image generation source 1 includes reflective or transmissive LC panel, or a light modulator element, such as a display element containing a plurality of small mirrors. The image generation source 1 also may be the one that includes a projection CRT. A projection lens 2, which is a component of a first optical system, projects an image generated by the image generation source 1 onto a projection screen 3. A reflecting mirror 4 is provided in the optical path extending from the projection lens 2 to the projection screen 3 in order to reduce the depth of the image display apparatus. A flexibly curved mirror 5 (“anamorphic aspheric mirror,” hereafter), which is a component of a second optical system, is installed between the projection lens 2 and the reflecting mirror 4. Light incoming from the projection lens 2 is reflected off of the anamorphic aspheric mirror 5, is led to the reflecting mirror 4, is reflected off of the reflecting mirror 4, and is then led to the projection screen 3. These components are housed inside a housing 6 and are fixed in predetermined positions therein. The image generation source 1, the projection lens 2, and the anamorphic aspheric mirror 5 are fixed to an optical system base 7 and are thereby integrated.

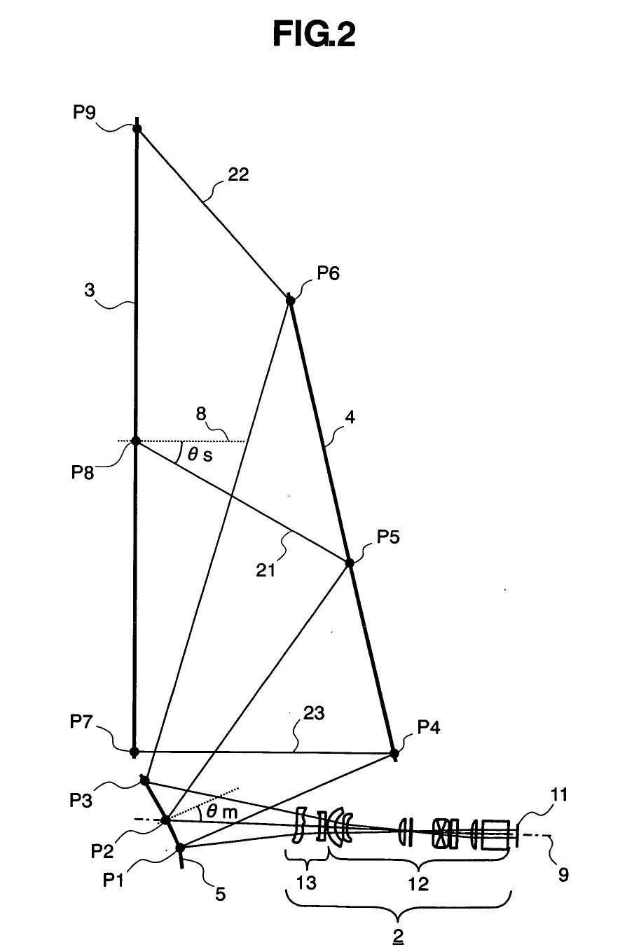

Features of components of a projection optical unit according to the present embodiment will be described herebelow with reference to FIG. 2.

FIG. 2 is a cross-sectional view showing a basic optical configuration of a rear-projection image display apparatus. More specifically, FIG. 2 shows the configuration of the optical system in the form of a YZ cross section on an XYZ rectangular coordinate system. It is assumed that the original point of the XYZ rectangular coordinate system is the center of a display screen constituting the image generation source 1, and the Z axis is parallel to the normal line of the projection screen 3. The Y axis is parallel to the short side of an image screen (image-displayed area) of the projection screen 3 and is identical to the vertical direction of the projection screen 3. The X axis is parallel to the long side of the image screen of the projection screen 3, and is identical to the horizontal direction of the projection screen 3.

As shown in FIG. 2, light emanated from an image display device 11 passes through a front group 12 of the projection lens 2 configured to include transmissive lens groups. The front group 12 includes a plurality of refractive lenses each having a rotationally symmetrical surface profile. Then, the light passes through a rear group 13 of the projection lens 2. The rear group 13 includes a lens of which at least one surface has a rotationally asymmetrical anamorphic aspheric surface profile (which lens hereafter will be referred to as an “anamorphic aspheric lens”). Then, the light is reflected off of at least one reflective mirror 5 having a reflective surface in a rotationally asymmetrical anamorphic aspheric surface profile (which hereinbelow will be referred to as an “anamorphic aspheric mirror”). Reflected light from the anamorphic aspheric mirror 5 is reflected off of the reflecting mirror 4, and is then incident on the projection screen 3.

In the case that the image display device 11 is formed of the light modulator element, although illumination systems for the light modulator element, such as lamps, are necessary, the components are omitted from the drawings. The image display device 11 may be of a type, such as a so-called three-plate type, which synthesizes a plurality of images. Also omitted from the drawings are synthesis optical systems such as prisms.

In the example shown in FIG. 2, the dimension of the projection lens 2 along the light passing direction is relatively long, such that it might be seen such that the image display device 11 is positioned distal with respect to the normal line of the projection screen 3 to the extent of increasing the depth.

In the present embodiment, however, mirrors (not shown) are disposed between the anamorphic aspheric mirror 5 and the rear group 13 of the projection lens 2, between the front group 12 and the rear group 13 of the projection lens 2, or in the midway to the front group 12. Thereby, the depth can be prevented from being increased in the manner that the optical axis of the projection lens 2 is bent along the direction substantially perpendicular to the cross section shown in FIG. 2.

According to the present embodiment, as shown in FIG. 2, the image display device 11 is disposed so that the center of a display screen thereof is positioned on the optical axis of the projection lens 2. As such, a light ray 21 output from the center of the display screen of the image display device 11 in the following manner. The light ray 21 passes through the center of an entrance pupil of the projection lens 2 along the direction to the screen center on the projection screen 3, and then propagates substantially along the optical axis of the projection lens 2 (the light ray hereafter will be termed “image center light ray”). After reflected off a point P2 existing on a reflecting surface of the anamorphic aspheric mirror 5, the image center light ray is reflected off a point P5 existing on the reflecting mirror 4. Then, the light ray is incident on a point P8 at the screen center of the projection screen 3 at a predetermined angle with respect to a normal line 8 of the projection screen 3 (that is, the light ray is diagonally incident thereon). The angle hereafter will be termed “diagonal incident angle” and will be represented by “θs”. In addition, depending on the case below, “diagonal incidence” or “diagonal projection” or variations thereof refers to the instance where light ray from the center of the display screen of the image display device 11 is incident diagonally with respect to the normal line 8 of the projection screen 3.

By the above it is meant that the configuration passed through along the optical axis of the projection lens 2 is diagonally incident on the projection screen 3, and the optical axis of the projection lens 2 is provided substantially diagonally with respect to the projection screen 3. In the event of the diagonal incidence of the light ray in the manner described above, there occur not only a so-called trapezoidal distortion, which refers to the case where a projected rectangular shape is changed to a trapezoidal shape, but also various other aberrations not symmetrical with respect to the optical axis. According to the present embodiment, however, such aberrations are compensated for by using the rear group 13 of the projection lens 2 and the reflective surface of the second optical system.

In the cross section shown in FIG. 2, light is radiated from an image-screen lower end of the image display device 11 through the image-screen lower end and the center of the entrance pupil of the projection lens 2. In this case, a light ray corresponding to the above-described light and incident on a point P9 existing on an image-screen upper end on the projection screen 3 is referred to as a light ray 22. Similarly, light is radiated from an image-screen upper end of the image display device 11 through the image-screen upper end and the center of the entrance pupil of the projection lens 2. In this case, a light ray corresponding to the light and incident on a point P7 existing on an image-screen lower end on the projection screen 3 is referred to as a light ray 23.

In FIG. 2, an optical path length extending from a point P3 to the point P9 via a point P6 is longer than an optical path length extending from a point P1 to the point P7 via a point P4. This means that, as viewed from the projection lens 2, an image point P9 is farther than an image point P7 on the projection screen 3. Suppose that an object point (point located on the display screen) corresponding to the image point P9 located on the projection screen 3 is located on a point closer to the projection lens 2, and an object point corresponding to an image point P7 is farther from the projection lens 2. In this case, the skew of the image plane can be compensated for. In order to perform the compensation, a normal vector in the center of the display screen of the image display device 11 is skewed with respect to the optical axis of the projection lens 2. In more specific, it is sufficient that the normal vector is skewed in the YZ plain toward the position of the projection screen 3. In this connection, there is known a method of skewing an object plain to obtain an image plain skewed with respect to an optical axis. However, at a practical degree of angle of viewing, an image plane formed with the skew of the object plain undergoes deformation asymmetrical with respect to the optical axis, thereby making it difficult to provide the compensation to a rotationally symmetrical projection lens 2. According to the present embodiment, however, the anamorphic aspheric surface, which is not rotationally symmetrical, i.e., rotationally asymmetrical, is used, so that distortions of the asymmetrical image plane can be handled. Consequently, by skewing the object plane, a low level distortion of the image plane can be significantly reduced. This is effective for assisting the aberration compensation being performed using the anamorphic aspheric surface.

Operations of the respective optical elements will now be described herebelow.

The first optical system, i.e., the projection lens 2, is a primary lens for being used such that the front group 12 thereof projects the display screen of the image display device 11 onto the projection screen 3. The projection lens 2 functions to compensate for the fundamental aberrations occurring in the rotationally symmetrical optical system. The rear group 13 of projection lens 2 includes the rotationally asymmetrical anamorphic aspheric lens.

In the present embodiment, the anamorphic aspheric lens is arcuately formed with a concave surface facing the light radiation direction thereof. The curvature of a portion of the anamorphic aspheric lens through which the light ray directed to the lower end of the projection screen 3 passes is set wider than the curvature of a portion thereof through which the light ray directed to the upper end of the projection screen 3 passes.

The second optical system includes the anamorphic aspheric mirror having the rotationally asymmetrical anamorphic aspheric surface profile. In the present embodiment, the anamorphic aspheric mirror is formed of a rotationally asymmetrical convex mirror having a portion arcuately formed such that a convex portion faces the reflection direction of the light ray. More specifically, the curvature of a portion of the anamorphic aspheric mirror for reflecting the light ray directed to the lower end of the projection screen 3 is set wider than the curvature of a portion of the mirror for reflecting the light ray directed to the upper end of the projection screen 3. Alternatively, the configuration may be as follows. The portion of the anamorphic aspheric mirror for reflecting the light ray directed to the lower portion of the projection screen 3 may have a convex shape in the reflection direction of the light ray. Concurrently, the portion of the mirror for reflecting the light ray directed to the upper portion of the projection screen 3 may have a concave shape in the reflection direction of the light ray.

In accordance with the operations of the anamorphic aspheric lens and the anamorphic aspheric mirror, primarily, the compensation for the aberrations caused by the diagonal incidence is performed.

That is, according to the present embodiment, the second optical system compensates for, primarily, the trapezoidal distortions, and the rear group 13 of the projection lens 2, i.e., the first optical system, compensates for, primarily, asymmetrical aberrations such as image plane distortions.

Thus, in the present embodiment, the first optical system includes at least one rotationally asymmetrical anamorphic aspheric lens, and the second optical system includes at least one rotationally asymmetrical anamorphic aspheric mirror. This enables the compensation for both the trapezoidal distortions and aberrations caused by the diagonal projection.

According to the configuration described above, in the projection lens 2 including the refractive surfaces, the compensation of the trapezoidal distortions caused by the diagonal incidence can be accomplished without causing lens eccentricity and lens-diameter increase and without the need of increasing the number of lenses. Further, a projection optical unit reduced in the depth and easily manufacturable can be implemented. Further, according to the present embodiment, a compactly integrated device set reduced in the depth and the height of the lower portion of the projection screen 3 can be provided. Further, an optical system using a small anamorphic aspheric mirror and easily manufacturable can be provided.

Thus, the above-described configuration of the present embodiment implements the compactly integrated device set reduced in the depth and the height of the lower portion of the projection screen 3 by using the anamorphic aspheric lens and the anamorphic aspheric mirror. Basically, however, the device set is still one of eccentric projection optical systems. Accordingly, a projected image incident on the project screen 3 is eccentric with respect to the project screen 3, and the center thereof is present below a lower end P7 of the project screen 3 (refer to FIG. 2).

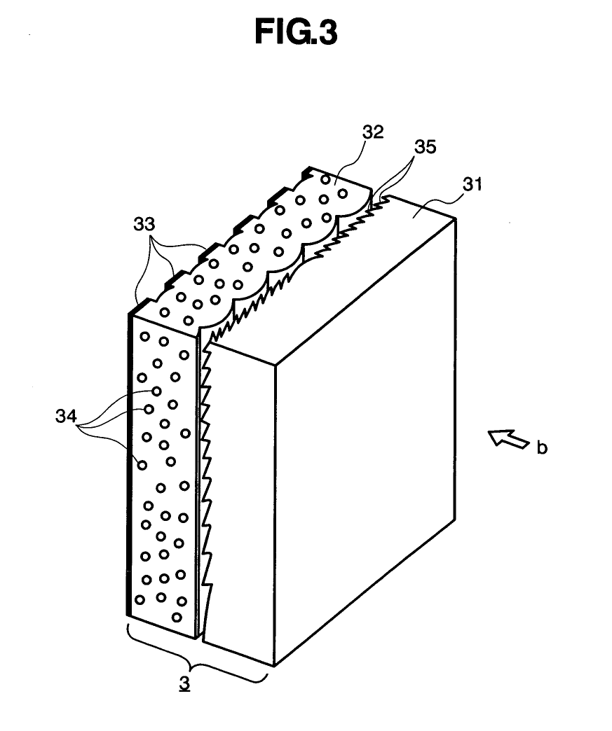

FIG. 3 is a schematic view showing the construction of the light-transmissive projection screen according to the present embodiment. A magnified projection image to be projected from the direction of an arrow b is transformed by a fresnel lens sheet 31 to substantially parallel light or light slightly inwardly biased, and is then incident on a lenticular lens sheet 32. As shown in FIG. 3, a light incident surface of the lenticular lens sheet 32 has a shape formed of a plurality of lenticular lenses arranged, in which the longitudinal direction of the respective lens is coincident with the vertical direction of the screen. Accordingly, the lenticular lens sheet 32 diffuses the image light along the horizontal direction of the screen. In addition, black stripes 33 extending along the vertical direction of the screen are formed on a radiation surface of the lenticular lens sheet 32. The black stripes 33 absorb external light that is incident from the radiation side of the screen. Further, a diffusing material 34 is mixed into the lenticular lens sheet 32. The diffusing material 34 exhibits the function of diffusing the image light along the horizontal and vertical directions of the screen.

The projection screen 3 according to the present embodiment, shown in FIG. 3, is formed such that the image generation source side of the fresnel lens sheet 31 is a plane, and a fresnel lens portion 35 is provided on the image viewing side. The fresnel lens portion 35 is formed into either a concentrically circular shape or arcuate shape. The arcuate shape is the shape of an arc that is a part of a concentric circle with the fresnel center as the center point. The shape including the concentric circular shape and the arcuate shape, hereafter, will be referred to as “concentric circular shape” or its variations. In the present embodiment, the fresnel center of the concentrically circular fresnel lens portion 35 exists either in the vicinity of a lower end portion of the fresnel lens sheet 31 or below the lower end portion (outside the fresnel lens sheet 31). Thus, the present embodiment is such that, in the case that the fresnel center exists either in the vicinity of the lower end of the fresnel lens sheet 31 or outside the lower end, a conjugate point is provided on the side of the fresnel lens sheet 31, that is, on the image viewing side. The conjugate point here refers to a point at which image light projected from a projection optical unit, such as a projection lens unit, is focused by the fresnel lens. The present embodiment is characterized in that the distance of the image-side conjugate point (shortly “conjugate point,” hereafter), more specifically, the distance along the screen normal line direction to the conjugate point from the projection screen 3 is appropriately set corresponding to the position of the fresnel lens. The distance described above hereafter will be shortly referred to as “conjugate point distance.”

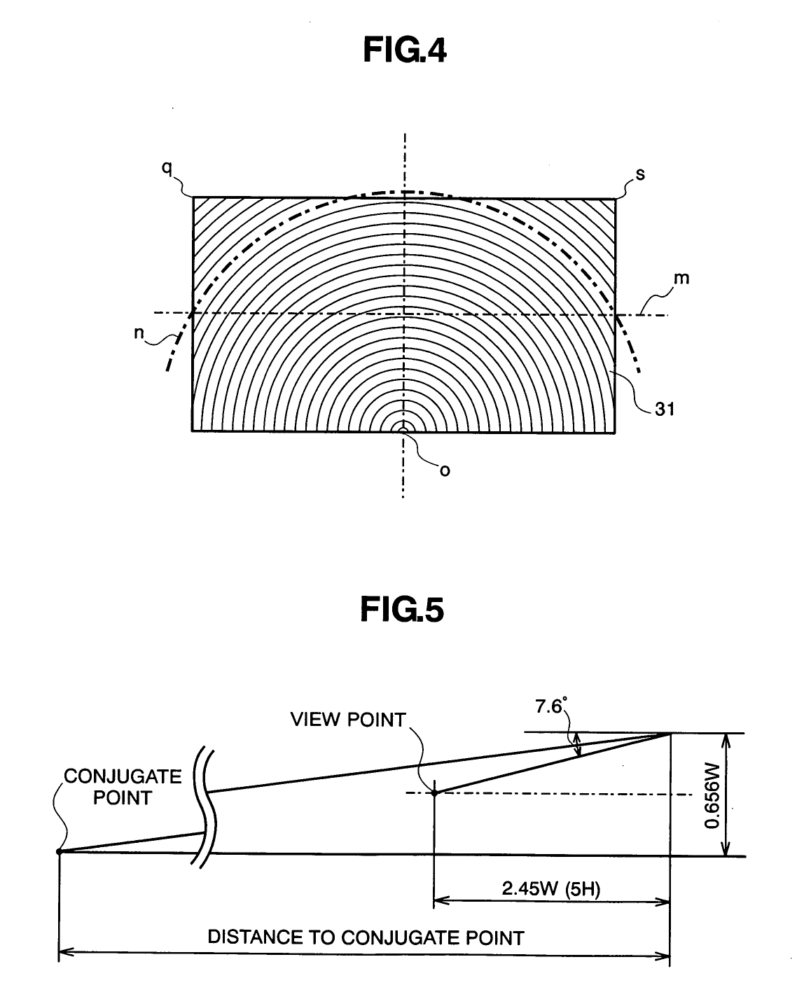

With reference to FIGS. 4 to 7, the following describes setting of the conjugate point of the fresnel lens sheet 31 for the projection screen 3 according to the present embodiment.

FIG. 4 is a schematic view of the fresnel lens sheet 31 as viewed from the image viewing side. In FIG. 4, a horizontal centerline m shown by a horizontally extending single-dotted chain line halves the fresnel lens sheet 31 into the upper and lower directions. A fresnel point o positioned at the lower end of the projection screen 3 represents the fresnel center. With reference to the horizontal fresnel lens sheet 31 as viewed from the image viewing side, as shown in FIG. 4, on the whole surface thereof there is formed a concentrically circular prism, which constitutes the fresnel lens with the fresnel point o set as the center point.

In the case that a conjugate point is provided in the entirety of the fresnel lens, light rays transferred through respective portions of the fresnel lens propagate extended portions of the center of the lower end portion of the fresnel lens sheet 31. As such, especially, the image light on a portion below the horizontal centerline m of the fresnel lens sheet 31 propagates below the line of sight of the viewer, such that the image in that portion becomes dark. To avoid this, according to the present embodiment, a reference circumference n with the fresnel point o set as the center point is determined. Thereby, a conjugate point distance of a first fresnel lens portion formed outside the reference circumference n (outside the radius of the reference circumference n) is shorter than a conjugate point distance of a second fresnel lens portion formed inside the reference circumference n (inside the radius of the reference circumference n).

In the present embodiment, the first fresnel lens portion conjugate point distance is set to infinity. That is, light is radiated substantially parallel to the normal line of the projection screen 3 from the first fresnel lens portion. In addition, the present embodiment, the reference circumference n is set to a circumference of the fresnel lens of the fresnel lens passing through the vicinities of cross points of the horizontal centerline m and both left and right ends of the fresnel lens sheet 31. That is, in the present embodiment, the conjugate point of the fresnel lens is provided only in the area above the horizontal centerline m of the fresnel lens sheet 31. The fresnel lens is concentrically circular shape, such that the conjugate point is provided only in the portion (area) outside the reference circumference n. This portion (area) corresponds to the opposite side of the side where the fresnel point o exists, that is, the area distal from the point o, in which portion the light amount is reduced since the angle of viewing of the projection optical system is large. More specifically, this area corresponds to a portion where the incident angle of the light projected from the projection optical system to the projection screen 3 becomes largest, and the light loss increases.

According to the present embodiment, however, a light ray in a portion positioned outside the reference circumference n, that is, a portion where the light amount is relatively reduced, can be directed to the viewer. Consequently, images on the projection screen 3, especially, image in the vicinities of the both left and right end portions can be brightly displayed.

In order to reduce the conjugate point distance of the second fresnel lens portion positioned outside the reference circumference n to be shorter than the conjugate point distance of the first fresnel lens portion positioned inside the reference circumference n, a prism angle of the refractive surface of the second fresnel lens portion (angle formed between the refractive surface and the normal line of the projection screen 3) is set wider than a prism angle of the refractive surface of the second fresnel lens portion.

In the above-described example, although the conjugate point distance of the first fresnel lens portion is set to infinity, the distance need not be set to infinity inasmuch as the conjugate point distance is longer than the conjugate point distance of the second fresnel lens portion. Further, in the above-described example, although the respective prism angle of the refractive surface of the fresnel lens on the same circumference is set constant, the prism angle may be set variable depending on the position on the same circumference.

The conjugate point distance will be described herebelow with reference to FIG. 5.

FIG. 5 is a lateral view of the fresnel lens sheet 31 shown in FIG. 4. In FIG. 4, the vertical direction does not represent the vertical dimension of the fresnel lens sheet 31, but it represents a line segment connecting between the fresnel center (point o in FIG. 4) of the fresnel lens sheet 31 and a left upper end (point q in FIG. 4) or right upper end (point s in FIG. 4). As such, where the corner-to-corner dimension or diagonal dimension is W, and the aspect ratio is 16:9, the vertical dimension is 0.656 W. According to a general practice, the viewing point is set to a distance of five times a vertical dimension H of the projection screen 3 along the extended line of the center of the projection screen 3 in orthogonal opposition to the projection screen 3 (i.e., it is set to the distance of 5 H or to 2.45 W as represented in the diagonal dimension W of the fresnel lens sheet 31). In the present case, since the vertical direction is not set to represent the vertical dimension of the fresnel lens sheet 31, a slight offset occurs. Nevertheless, however, since significant effects are not imposed in practice, the point as shown in FIG. 5 is herein used as the viewing point for the sake of simplifying description.

Referring to FIG. 5, when the left (right) upper end of the projection screen 3 from the viewing point is taken into account, there occurs a skew of 7.6 degrees from the normal line of the projection screen 3.

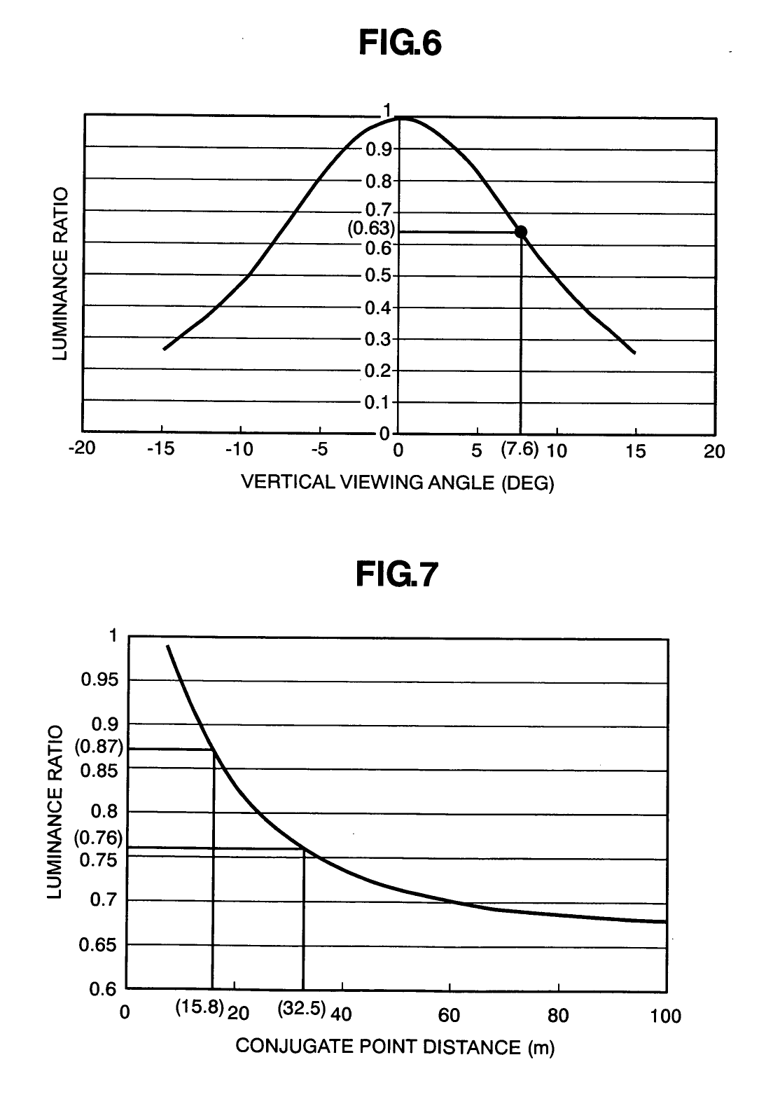

FIG. 6 shows a graph showing the characteristics of vertical viewing angles of a general light-transmissive screen. In the characteristics graph, the horizontal axis represents the angle, and the vertical axis represents the luminance ratio. It can be seen that, when the luminance along the direction of the normal line is 1.0, the angle of 7.6 degrees causes the deterioration of the luminance to 0.63. As described in conjunction with FIG. 4, the luminance deterioration can be restrained when the conjugate point is provided in the area outside the reference circumference n. However, in the case of the conjugate point provided too close to the screen, while the brightness is high at the viewing point, conversely the brightness is reduced at a point with a slight offset. As such, the distance to the conjugate point has to be appropriately determined. In this connection, with reference to FIG. 4, it has been described that the range for the provision of the conjugate point in the fresnel lens is set outside of the reference circumference n. The position of the reference circumference n is set to a distance of 0.5 W from the fresnel center. As such, in view of the reference circumference n from the viewing point shown in FIG. 5, the line segment connecting between the reference circumference n and the viewing point has a skew of 4.0 degrees from the normal line of the projection screen 3. The luminance ratio at those points obtained from FIG. 6 is 0.87, so that it can be known that the luminance ratio at the left (right) upper end should not be set to 0.87 to obtain natural luminance distributions.

FIG. 7 is a diagram showing the relationships between conjugate point distances and luminance ratios at the upper left (right) end of the projection screen 3 in the case that the diagonal dimension of the fresnel lens sheet 31 is set to 60 inches (1.52 m (meters)), and aspect ratio is set to 16:9. It could be understandable from FIG. 7 that the conjugate point distance for achieving the luminance ratio of 0.87 is 15.8 m. When the conjugate point distance is generalized to the diagonal dimension W, it is 10.3 W. In the present embodiment, where W is the diagonal dimension of the fresnel lens sheet 31, and k is a coefficient, a conjugate point distance L is represented by equation (1) below.
L=kW (1)

In the above-described example, k is 10.3. In addition, it can be understood from FIG. 7 that when a minimum increase rate of the luminance ratio is 15%, the luminance ratio is 0.76, and the conjugate point distance is 32.5 m. In this example, the coefficient k is 21.3.

Thus, in the fresnel lens sheet 31 according to the present embodiment, the conjugate point is provided only in the fresnel lens formed outside the reference circumference n, or in other expression, formed in the portion above the horizontal centerline m. Then, where the conjugate point distance L is represented by the product of the multiplication between the diagonal dimension W of the fresnel lens sheet 31 and the coefficient k, k is set to a range of from 10.3 to 21.3. While the conjugate point distance is variable depending on the vertical viewing angle as viewed in FIG. 6, it is set to about 10 W or longer, and preferably to a range of from 10 W to 25 W.

The present embodiment has thus been described with reference to the example cases where images are projected from the lower portion onto the projection screen 3. However, the configuration of the present embodiment can be similarly adapted even to the case where images are projected from an upper portion onto the light-transmissive projection screen 3. In this case, the fresnel lens sheet 31 is reversed upside down, the conjugate point is provided in a range below the horizontal centerline (m) of the fresnel lens sheet 31. Also in this case, the conjugate point distance is the same as in the case of projection performed from the lower portion onto the light-transmissive projection screen 3.

According to the fresnel lens sheet 31 provided with the conjugate point, the fresnel angle is increased, reflection losses in the fresnel lens are increased.

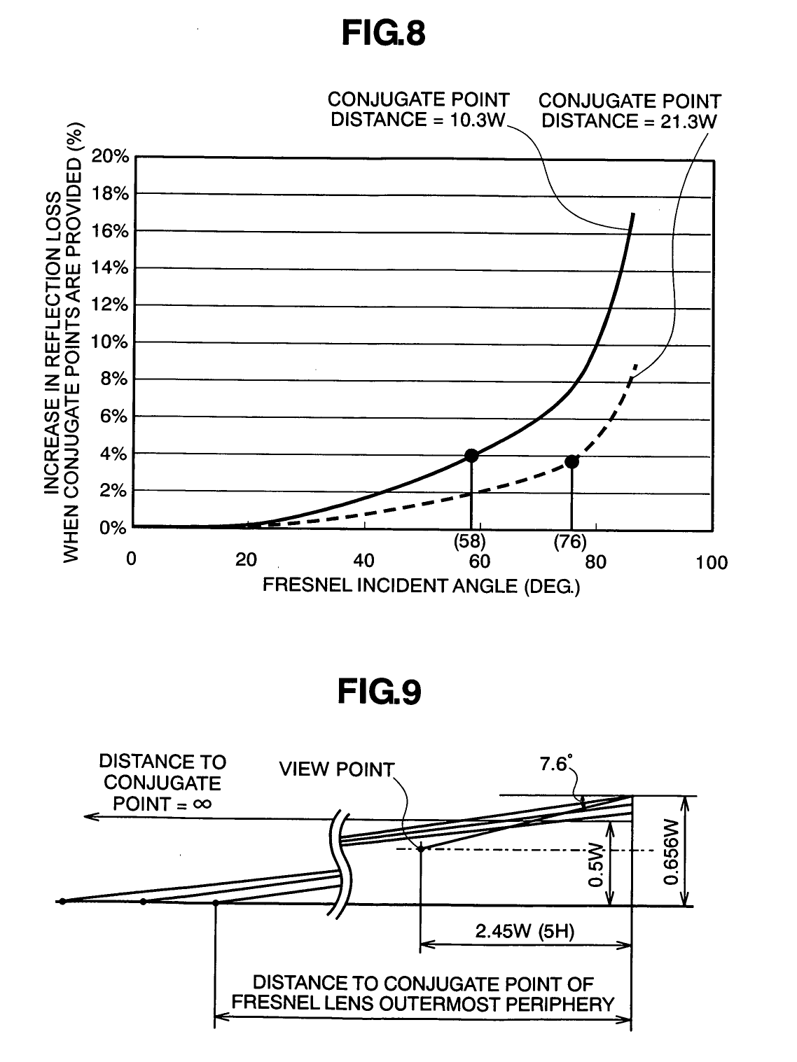

Referring to a graph of FIG. 8, the horizontal axis of the graph represents a fresnel incident angle. More specifically, the graph shows the characteristics of increase in the reflection loss in a fresnel lens having a conjugate point for the variation (increase) in the fresnel incident angle. The fresnel incident angle herein refers to the angle formed between the light ray projected from the image generation source onto the projection screen 3 and the normal line of the projection screen 3. The solid line shown in FIG. 8 represents a case where the coefficient is set to 10.3, the broken line represents a case where the coefficient k is set to 21.3. Clearly from the graph, the reflection losses become greater in the case that the conjugate point is set to the position closer to the fresnel lens sheet 31. It can also be known that the reflection losses sharply increase when exceeds 4%. Accordingly, it can be understood that in the case of 4% being set as a limit of the increase in the reflection loss, when the coefficient k is set to 10.3, then the fresnel incident angle has to be restricted to 58 degrees or smaller; and when the coefficient k is set to 21.3, the fresnel incident angle has to be restricted to 76 degrees or smaller. The relationship between a fresnel incident angle (δ) and a conjugate point distance (L=W) that causes the increase of 4% in the reflection losses obtained in a manner similar to the above is expressed by an approximation expression as given in equation (2).
kW=1.0583 exp(0.0387×δ) (2)

In this case, the coefficient k is “1.0583 exp(0.0387×δ)/W.” More specifically, when a maximum fresnel incident angle is δ (degrees), the conjugate point distance L has to be set to kW or longer, and more specifically, has to be set to satisfy equation (3):
L≧1.0583 exp(0.0387×δ) (3)

According to the embodiment described above, one conjugate point is provided to the second fresnel lens portion, a plurality of conjugate points may be provided thereto.

FIG. 9 is a view of a fresnel lens sheet 31 according to another embodiment of the present invention. FIG. 9 shows a lateral view of the fresnel lens sheet 31, in which, similar to FIG. 5, the vertical direction does not represent the vertical dimension of the fresnel lens sheet 31. That is, the vertical direction represents the line segment connecting between the fresnel center (point o shown in FIG. 4) and the left upper end (point q shown in FIG. 4) or right upper end (point s shown in FIG. 4) of the fresnel lens sheet 31. The positions and dimensions of the respective portions are identical to those shown in FIG. 5. A difference from the configuration shown in FIG. 5 is that although one conjugate point is provided to the second fresnel lens portion in the configuration of FIG. 5, a plurality of conjugate points are provided to the second fresnel lens portion in the configuration of FIG. 9.

As described in conjunction with FIG. 5, conjugate points are provided in respective positions, starting from a position at a height of 0.5 W (i.e., reference circumference n) from the center position at the lower end of the fresnel lens sheet 31. Similarly as the case of setting to the height of 0.5 W, an initial conjugate point is provided by setting the conjugate point distance to infinity (radiation light ray is perpendicular to the fresnel lens sheet 31). Concurrently, the conjugate point distance is set to be shortest at a point at the left upper end or right upper end of the fresnel lens sheet 31, that is, the point at which the incident light ray has the maximum fresnel incident angle with respect to the fresnel lens. More specifically, in the present embodiment, the conjugate point distances in the second fresnel lens portion are set to become gradually short from the reference circumference n toward the outside thereof. In this case, the number of conjugate points in the second fresnel lens portion may be optional inasmuch as it is two or more, and the conjugate point may even be varied in units of one pitch in the second fresnel lens portion. Thereby, compared to the embodiment shown in FIG. 5, the luminance continuity on the projection screen 3 can be made smoother.

The present invention has been described only with reference to preferred embodiments for example purposes and in the interest of brevity, and that the present invention is not limited to these embodiments. Those skilled in the art will understand that various alterations and modifications can be made to the embodiments discussed herein and that all such modifications are within the scope of the present invention.

What is claimed is:

1. A projection screen onto which light from an image generation source is magnified and projected, the projection screen comprising:
a fresnel lens sheet; and
a diffusion sheet that is disposed on an image viewing side of the fresnel lens sheet and that causes image light to diffuse along at least an screen's horizontal direction,
wherein, in the fresnel lens sheet:
a plurality of fresnel lenses is formed concentrically circularly or arcuately with a fresnel center as a center point on a light irradiation surface;
the fresnel center is positioned in either one of a vicinity and an outside of a lower end of the fresnel lens sheet or one of a vicinity and an outside of an upper end of the fresnel lens sheet;
the fresnel lens includes a first fresnel lens portion formed inside a reference circumference with the fresnel center as a center point, and a second fresnel lens portion formed outside the reference circumference; and
a distance on an image-side conjugate point of the second fresnel lens portion is shorter than an image-side conjugate point of the first fresnel lens portion.

2. A projection screen as claimed in claim 1, wherein a light ray from a center of the image generation source is projected from a diagonal direction with respect to a normal line of the fresnel lens sheet.

3. A projection screen as claimed in claim 1, wherein the distance of the image-side conjugate point of the first fresnel is substantially infinite.

4. A projection screen as claimed in claim 1, wherein the second fresnel lens portion includes distances of a plurality of image-side conjugate points.

5. A projection screen as claimed in claim 4, wherein the distances of the image-side conjugate points of the second fresnel lens portion become gradually short toward the outside from the reference circumference.

6. A projection screen as claimed in claim 4, wherein, where a diagonal dimension of the projection screen is W, a shortest distance of a conjugate point of the plurality of image-side conjugate points of the second fresnel lens portion is about 10 W or longer.

7. A projection screen as claimed in claim 4, wherein, where a diagonal dimension of the projection screen is W, a shortest distance of a conjugate point of the plurality of image-side conjugate points of the second fresnel lens portion is in a range of from about 10 W to 25 W.

8. A projection screen as claimed in claim 4, wherein, where an angle (fresnel incident angle) formed between light incident on an arbitrary point of the second fresnel lens portion and a normal line of the projection screen is δ, a distance L of a respective one of the image-side conjugate points satisfies conditions of
L≧1.0583 exp(0.0387×δ)

9. A projection screen to be used in a projection image display apparatus, the projection screen comprising:
a fresnel lens sheet; and
a diffusion sheet that is disposed on an image viewing side of the fresnel lens sheet and that causes image light to diffuse along at least an screen's horizontal direction,
wherein, in the fresnel lens sheet:
a plurality of fresnel lenses is formed concentrically circularly or arcuately with a fresnel center as a center point on a light irradiation surface;
the fresnel center is positioned in either one of a vicinity and an outside of a lower end of the fresnel lens sheet or one of a vicinity and an outside of an upper end of the fresnel lens sheet; and
with respect to a reference set to a horizontal centerline halving the fresnel lens sheet along upper and lower directions, at least a portion of a fresnel lens formed in a distal area from the fresnel center includes an image-side conjugate point.

10. A projection screen as claimed in claim 9, wherein, of fresnel lenses formed in an area wherein the fresnel center does not exist, a fresnel lens positioned outside a circumference of a fresnel lens that passes through vicinities of points whereat the horizontal centerline crosses with left and right ends of the fresnel lens sheet includes a conjugate point.

11. A projection screen as claimed in claim 10, wherein, where a diagonal dimension of the projection screen is W, the distance from the projection screen to the image-side conjugate point is about 10 W or longer.

12. A projection screen as claimed in claim 10, wherein, where a diagonal dimension of the projection screen is W, the distance from the projection screen to the image-side conjugate point is in a range of from about 10 W to 25 W.

13. A projection screen as claimed in claim 10, wherein, where an angle (fresnel incident angle) formed between light incident on an arbitrary point of the second fresnel lens portion and a normal line of the projection screen is δ, a distance L of the image-side conjugate point at the point satisfies conditions of
L≧1.0583 exp(0.0387×δ)

14. An image display apparatus, comprising:
an image generation source;
a light-transmissive projection screen including at least a fresnel lens sheet and a diffusion sheet that is disposed on an image viewing side of the fresnel lens sheet and that causes image light to diffuse along at least an screen's horizontal direction, wherein, in the fresnel lens sheet a plurality of fresnel lenses is formed concentrically circularly or arcuately with a fresnel center as a center point on a light irradiation surface, the fresnel center is positioned in either one of a vicinity and an outside of a lower end of the fresnel lens sheet or one of a vicinity and an outside of an upper end of the fresnel lens sheet, the fresnel lens includes a first fresnel lens portion formed inside a reference circumference with the fresnel center as a center point and a second fresnel lens portion formed outside the reference circumference, and a distance on an image-side conjugate point of the second fresnel lens portion is shorter than an image-side conjugate point of the first fresnel lens portion; and
an optical component that magnifies and projects an image of the image generation source onto the light-transmissive projection screen and that projects an light ray from a center of the image generation source from a diagonal direction with respect a normal line of the screen.

15. An image display apparatus as claimed in claim 14, wherein the second fresnel lens portion includes distances of a plurality of image-side conjugate points.

16. A projection screen as claimed in claim 15, wherein the distances of the image-side conjugate points of the second fresnel lens portion become gradually short toward the outside from the reference circumference.

17. An image display apparatus as claimed in claim 14, wherein, of fresnel lenses formed in an area wherein the fresnel center does not exist, a fresnel lens positioned outside a circumference of a fresnel lens that passes through vicinities of points whereat the horizontal centerline halving the fresnel lens sheet in the upper and lower directions crosses with left and right ends of the fresnel lens sheet includes a conjugate point.

18. An image display apparatus as claimed in claim 14, wherein, where a diagonal dimension of the projection screen is W, the distance from the projection screen to the image-side conjugate point is in a range of from about 10 W to 25 W.

19. An image display apparatus as claimed in claim 14, wherein, where an angle (fresnel incident angle) formed between light incident on an arbitrary point of the second fresnel lens portion and a normal line of the projection screen is δ, a distance L of the image-side conjugate point at the point satisfies conditions of
L≧1.0583 exp(0.0387×δ)
